(19) United States
(12) Patent Application Publication
(10) Pub. No.: US 2009/0324128 A1
(43) Pub. Date: Dec. 31, 2009

(54) APPARATUS AND METHOD FOR REDUCING TRANSITION ARTIFACTS IN AN OVERALL IMAGE COMPOSED OF SUB-IMAGES

(76) Inventors: Matthias Kube, Fuerth (DE); Oliver Scholz, Moehrendorf (DE); Rolf Behrendt, Dormitz (DE)

Correspondence Address: GLENN PATENT GROUP, 3475 EDISON WAY, SUITE L, MENLO PARK, CA, 94025, US

(21) Appl. No.: 12/438,129

(22) PCT Filed: Aug. 22, 2007
(86) PCT No.: PCT/EP2007/007389

§ 371 Date: Sep. 3, 2009

(30) Foreign Application Priority Data
Aug. 22, 2006 (DE) 10 2006 039 389.9

(51) Int. Cl. G06K 9/40

(52) U.S. Cl. 382/275

(57) ABSTRACT

The present invention provides an apparatus and a method for reducing transition artifacts in an overall image composed of sub-images whose image areas have overlap areas. The apparatus includes a storer for storing image data of the pixels of the sub-images, and a generator for generating the overall image, on the basis of the image data of the sub-images by superposition of the image data of the pixels in the overlap area in accordance with a weighting, the weighting being configured such that any influence of a pixel of a sub-image which would cause an artifact in the overall image is reduced in the overall image.

### CROSS-REFERENCE TO RELATED APPLICATIONS

This application is a national phase entry of PCT Patent Application Serial No. PCT/EP2007/007389, filed 22 Aug. 2007, which claims priority to German Patent Application No. 10 2006 039 389.9, filed 22 Aug. 2006.

### BACKGROUND OF THE INVENTION

The present invention relates to an apparatus and a method for reducing transition artifacts in an overall image composed of sub-images whose image areas have overlap areas as occur, for example, when using several cameras for capturing an image area which is larger than the image area of an individual camera.

The technical field of application of the invention described here advantageously comprises processing X-ray image data, in particular in industrial quality control of products which is performed by means of X-radiation. An important case of application is the detection of shrink holes, porosities or other blemishes in castings such as aluminum wheels. Since the imaging area of the test pieces in this field of application is often very large, an individual test piece cannot be tested by means of individual image pickups. As is inherent to their functional principle, X-ray photographs additionally exhibit image noise, which results in that several individual photographs may be able to perform averaging of the individual photographs and to obtain a usable image.

To keep the test time as short as possible, several cameras or X-ray detectors are used for composing an overall image from several individual photographs. The individual photographs are subject to pre-processing, in particular X-ray photographs for quality control of products which is performed by means of X-radiation or computer tomography. The dimensions of the objects to be tested, i.e. of the test pieces, are becoming increasingly large so that increasingly large detector surface areas become extremely useful.

X-ray detectors exhibiting relatively large imaging surface areas are composed of individual sensors. A differentiation may be made between overlapping and disjoint sensors, overlapping sensors meaning that image areas of adjacent sensors overlap, whereas with disjoint sensors, the image areas of adjacent sensors do not intersect. Due to different sensitivities, different characteristic curves, which are caused by production tolerances, for example, the sensors of a detector exhibit different behaviors across the operating range with identical irradiation. If an overall image is composed of the individual images, gray-scale jumps, which are perceivable in the image as edges and interfere with image processing, result at the points of transition and/or overlap. This effect occurs even if the overall image was previously subjected to brightness correction.

Errors may occur in the evaluation of such an image which exhibits gray-scale jumps at the points of overlap of the individual images. Actual defects in the test piece, such as air bubbles, porosities or cracks, for example, also have gray-scale variations in the X-ray image, so that any automated evaluation of a composed overall image may possibly not distinguish between gray-scale jumps in overlap areas and actual blemishes.

DE 103 01 941 B4 describes a camera and a method for optical recording of a screen. In this context, the camera comprises a camera support with an array of camera mounts to which individual optical cameras are attached, as well as an image processing means for processing digital individual images of the array of individual optical cameras so as to generate an optical pickup of the screen in a predetermined overall resolution. In this context, the image processing means performs correction of the individual images with regard to alignment inaccuracies and/or parameter fluctuations, a correction resolution being used, for correction purposes, which is higher than the overall resolution, and a dedicated correction specification being used for correcting for each individual camera. Thus, a geometric correction of the individual images is conducted before they are combined into an overall image. The geometric correction comprises aligning the individual images both in a rotational and translational manner. Once the correction has been conducted, the corrected overall image is brought to the predetermined overall resolution by combining adjacent pixels. In this manner, utilization of favorable individual cameras enables efficient, low-cost and low-artifact imaging of a large-format screen. What is problematic in this context are the image processing times, since joining the individual images may take up a lot of time, it being possible for the process times to increase disproportionately as the number of individual images increases. What is problematic are the points of overlap of the individual images, since these may result in diagnostic errors in the testing in case of automated evaluation.

In practice, defective pixels frequently occur in sub-images. These defective pixels may be due to aging phenomena of the cameras or detectors, on the one hand, but may also be caused by hardware defects, on the other hand. Defective pixels frequently lead to artifacts in the sub-images or overall images. These artifacts make automated evaluation of the image data more difficult, since they are often interpreted as defects in or on a test piece.

### SUMMARY OF THE INVENTION

According to an embodiment, an apparatus for reducing transition artifacts in an overall image composed of sub-images whose image areas include overlap areas may have: a storer for storing image data of the pixels of the sub-images; and a generator for generating the overall image on the basis of the image data of the sub-images by superposition of the image data of the pixels in the overlap areas in accordance with a weighting, each of the subareas in the overlap area including a weighting function associated with it, and the weighting functions of the sub-images being modified, in the event of a defective pixel in one of the sub-images, at the position of the defective pixel such that the defective pixel is faded out entirely and that only intact pixels of the other sub-images are used, so that any influence of an incorrectly detected pixel of a sub-image which would cause an artifact in the overall image is reduced in the overall image.

According to another embodiment, a method for reducing transition artifacts in an overall image composed of sub-images whose image areas include overlap areas may have the steps of: storing the image data of the pixels of the sub-images; and generating the overall image on the basis of the image data of the sub-images by superposition of the image data of the pixels in the overlap areas in accordance with a weighting, each of the subareas in the overlap area including a weighting function associated with it, and the weighting functions of the sub-images being modified, in the event of a defective pixel in one of the sub-images, at the position of the defective pixel such that the defective pixel is faded out entirely and that only intact pixels of the other sub-images are used, so that any influence of an incorrectly detected pixel of a sub-image which would cause an artifact in the overall image is reduced in the overall image.

Another embodiment may include a computer program having a program code for performing the method for reducing transition artifacts in an overall image composed of sub-images whose image areas include overlap areas, the method having the steps of: storing the image data of the pixels of the sub-images; and generating the overall image on the basis of the image data of the sub-images by superposition of the image data of the pixels in the overlap areas in accordance with a weighting, each of the subareas in the overlap area including a weighting function associated with it, and the weighting functions of the sub-images being modified, in the event of a defective pixel in one of the sub-images, at the position of the defective pixel such that the defective pixel is faded out entirely and that only intact pixels of the other sub-images are used, so that any influence of an incorrectly detected pixel of a sub-image which would cause an artifact in the overall image is reduced in the overall image, when the program code is executed on a computer.

The present invention provides an apparatus and a method for reducing transition artifacts in an overall image composed of sub-images whose image areas have overlap areas.

This object is achieved by an apparatus for reducing transition artifacts in an overall image composed of sub-images whose image areas have overlap areas. The apparatus comprises a means for storing image data of the pixels of the sub-images, and further includes a means for generating the overall image on the basis of the image data of the sub-images by superposition of the image data of the pixels in the overlap areas in accordance with a weighting, the weighting being configured such that any influence of a pixel of a sub-image which would cause an artifact in the overall image is reduced in the overall image.

The present invention further provides a method for reducing transition artifacts in an overall image composed of sub-images whose image areas have overlap areas. The inventive method comprises a step of storing the image data of the pixels of the sub-images, and further a step of generating the overall image on the basis of the image data of the sub-images by superposition of the image data of the pixels in the overlap areas in accordance with a weighting, the weighting being configured such that any influence of a pixel of a sub-image which would cause an artifact in the overall image is reduced in the overall image.

The present invention has the advantage that in accordance with embodiments of the present invention, for example in the merging of sub-images, by means of an area or line camera consisting of several sensors and having overlapping image areas, artifacts are reduced. For example, intensities of individual pixels are added up in a weighted manner while exploiting an overlap area so as to thereby achieve a smoothing or slower cross-fading of a potential gray-scale jump. In addition, embodiments of the present invention enable taking into account, by means of the weighting, defects in sub-images when combining the sub-images into an overall image. In embodiments, a defective pixel in a sub-image may be faded out by means of corresponding weighting, whereas a correct pixel from another sub-image may be faded in accordingly.

The weighting or weighting functions may take any forms, for example, they may comprise jumps or points of discontinuity for defective pixels. Since in embodiments, the sub-images may undergo, prior to the combination, geometric corrections such as rotations or displacements, for example, the overlap areas of the sub-images may take any form in the overall image, in particular when more than two sub-images overlap. In embodiments of the present invention, the weighting is adapted to the respective overlap areas, i.e. cross-fading may be realized while taking into account the shape of an overlap area.

Embodiments of the present invention considerably reduce the artifacts developing in the overlap areas, and therefore contribute to more reliable quality control of large-area test pieces. Since, consequently, a considerably reduced number of diagnostic errors occur in the quality control, production of such components may be performed more efficiently.

### BRIEF DESCRIPTION OF THE DRAWINGS

Embodiments of the present invention will be detailed subsequently referring to the appended drawings, in which:

FIG. 1 shows a general block diagram of an embodiment of the present invention;

FIG. 2a shows, by way of example, the overlap area of two sub-images;

FIG. 2b shows the curves of two exemplary weighting functions;

FIG. 3a shows, by way of example, three pixels, respectively, of two overlapping sub-images which are accurately aligned against one another;

FIG. 3b shows, by way of example, three pixels, respectively, of two sub-images which are not accurately aligned against one another; and

FIG. 3c shows four pixels, respectively, of two overlapping sub-images in order to generally illustrate the overlap;

FIG. 4 shows an embodiment of two non-linear weighting functions;

FIG. 5 shows a further embodiment of two non-linear weighting functions;

FIG. 6 shows a further embodiment of two non-linear weighting functions;

FIG. 7a shows an embodiment of a non-rectangular overlap area; and

FIG. 7b shows a further embodiment of a non-rectangular overlap area.

### DETAILED DESCRIPTION OF THE INVENTION

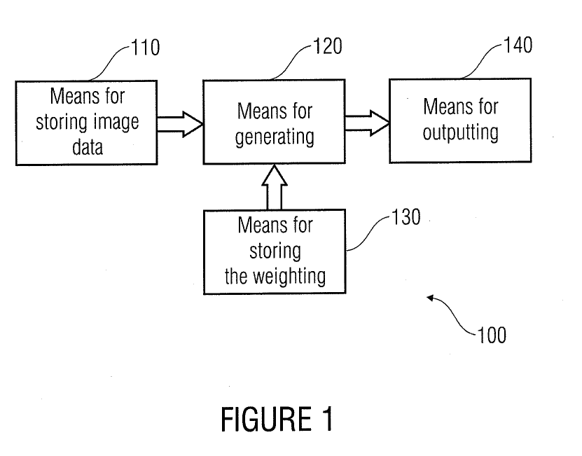

FIG. 1 shows a general block diagram of an embodiment of an inventive apparatus 100. The apparatus 100 for reducing transition artifacts in an overall image composed of sub-images whose image areas have overlap areas, comprises a means 110 for storing image data of the pixels of the sub-images. The apparatus 100 further comprises a means for storing image data of the pixels of the sub-images, and further includes a means for generating the overall image on the basis of the image data of the sub-images by superposition of the image data of the pixels in the overlap areas in accordance with a weighting, the weighting being configured such that any influence of a pixel of a sub-image which would cause an artifact in the overall image is reduced in the overall image. The means 110 for storing is coupled to the means 120 for generating such that the means 110 for storing may make the stored image data available. In this context, the sub-images may comprise overlap areas which are not rectangular.

Optionally, the apparatus 100 may further comprise a means 130 for storing the weighting. Also optionally, the apparatus 110 may additionally comprise a means for outputting 140 the overall image. The means for outputting 140 may be implemented, for example, by an output memory or a data output. The means for storing 130 is coupled to the means 120 for generating the overall image such that it may make data available to the weighting. In one embodiment of the present invention, the means 120 for generating the overall image is coupled, in turn, to the means 140 for outputting such that it may transmit the image data of the overall image.

The means 110 for storing image data may be implemented, for example, by a memory which is connected downstream from an array of cameras and stores the individual images. With regard to the inventive apparatus 100, the means 110 for storing image data acts as an input memory for the means 120 for generating the overall image, which may be implemented by an arithmetic unit, for example. Optionally, the means 120 for generating the overall image obtains the weighting from the means 130 for storing the weighting, which may, in turn, be realized as a memory which makes available coefficients for correcting the individual images. Accordingly, the means 130 for storing the weighting may be implemented as a correction memory. In principle, embodiments without the means 130 for storing and without the means 140 for outputting are also feasible. For example, a weighting could also be re-calculated or re-determined again and again by the means 120 for generating the overall image.

As is shown in FIG. 1 by way of example, embodiments of the inventive apparatus 100 may also consist of several image memories which realize the means 110 for storing the image data and which contain the sub-images captured by individual camera modules. The means 120 for generating, which may be realized as an arithmetic unit, for example, conducts the calculations for reducing the artifacts, and in a further embodiment it might be a microcontroller or processor. The optional means 130 for storing the weighting acts as a correction memory having the weightings of the individual images stored therein. This weighting may depend, for example, on the geometric position of a pixel in a sub-image relative to an overlap area with a second sub-image. This dependence may be calculated once-only and may subsequently be stored in the means 130 for storing the weighting. This would be the case, for example, in an embodiment wherein individual cameras are mounted on a rigid support, so that their relative positions to one another, and therefore also the positions of the sub-images to one another, are static. Once the individual correction factors have been determined once-only, they may be stored in a means 130 for storing the weighting. The processed data, or the overall image, is then output for subsequent processing operations, which may optionally be performed by a means 140 for outputting, which in turn may be realized, for example, by a memory or by a display device.

The sub-images of the individual camera modules should overlap so that the correction described herein may be performed. If, for example, M sub-images overlap, the data from the respective source images will be averaged in a weighted manner, in accordance with the following specification, in a transition area when the corresponding coordinate origin is selected for each sub-image:

$$p ( x , y ) = {\sum }_{i = 1}^{M} {W}_{i} ( x , y ) \cdot {p}_{i} ( x , y ) \\ with \\ {\sum }_{i = 1}^{M} {W}_{i} ( x , y ) = 1 , \qquad ( eq . 1 )$$

wherein Wᵢ(x,y) represents a weighting function, and pᵢ(x,y) represents the value of the pixel in the sub-image i at the coordinates (x,y).

The value of a pixel pᵢ(x,y) at the position (x,y) may comprise, for example, intensity information, so that the intensity of a pixel in the overall image in an overlap area is determined from a linear combination of the intensity information of the pixels of the sub-images. The weighting function Wᵢ(x,y) in this context associates weighting factors with the individual pixels of the sub-images i, for example in dependence on the geometric position of a pixel and on the geometric position of the overlap area, in accordance with a linear specification, which in other embodiments may also be non-linear.

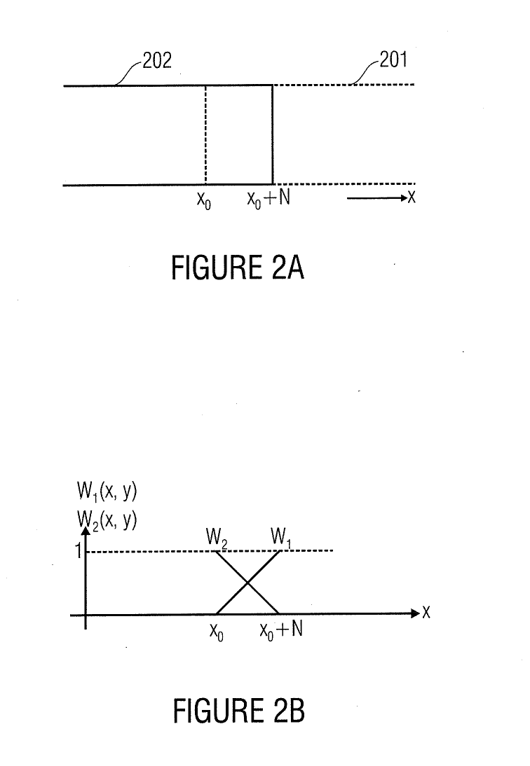

The weighting function may be linearly determined, for example, with an overlap of two sub-images in the horizontal direction with a width of N pixels. This embodiment is initially illustrated in FIG. 2a. FIG. 2a shows two overlapping sub-images 201 and 202, the contour of the sub-image 201 being indicated by dashed lines for illustration purposes. FIG. 2a further indicates a control variable x, which takes on increasing values in the direction of the right-hand side of the image. In the area x₀, i.e. the point where the sub-image 201 starts (left-hand margin), the overlap area of the two sub-images 201 and 202 extends as far as the coordinate x₀+N, i.e. that point where the sub-image 202 starts (right-hand margin), so that an overlap area of N pixels results. To impose different weighting factors on the pixels of the two sub-images 201 and 202 as a function of their geometric positions, the embodiment illustrated in FIGS. 2a and 2b uses a weighting function within the definition range {x₀, . . . , x_{0+N}}, i.e. a weighting function defined within the overlap area.

Two exemplary functions

W₁(x,y)=(x−x₀)/N and

W₂(x,y)=(N−(x−x₀))/N

are depicted in FIG. 2b. W₁(x,y) designates the weighting factors with which the image data of the pixels of the sub-image 201 is weighted. In the embodiment contemplated here, there is no dependence of the weighting functions W₁(x,y) and W₂(x,y) on the coordinate y. Generally, dependencies on both coordinates x and y are possible. The curve of the function W₁(x,y) in FIG. 2b indicates that the weighting factors at the left-hand edge of the overlap area, i.e. at x₀, initially start at 0 and then increase, across the overlap area, as far as the factor of 1. This results in that image data of the pixels of the sub-image 201 is weighted less, the further it projects into the overlap area. This also applies to the image data of the pixels of the sub-image 202. The curve of the weighting factors of the associated weighting function W₂(x,y) is also depicted in FIG. 2b. Because of the mirrored position, the weighting factors of the pixels of the sub-image 202 initially start with a factor of 1 and then drop, across the overlap area, as low as a weighting factor of 0, so that also for the sub-image 201, pixels are weighted less as they move further toward the margin of the sub-image.

In the embodiment shown in FIGS. 2a and 2b it is assumed that the weighting functions W₁(x,y) and W₂(x,y) do not depend on y, and that therefore no changes occur in the weighting factors in the vertical direction. In principle, other weighting functions are also feasible, for example with vertically overlapping sub-images or in the corner areas, it being possible, in general, for more than two images to overlap. Embodiments of the present invention are characterized in that pixels are weighted and superposed, it being possible for the specification of the weighting to be dependent on the geometry of the arrangement both in a linear and in a non-linear manner, and for dependencies of the weighting on other parameters to occur. In accordance with an identical, above-described calculation of an output pixel p(x,y) of the overall image, a non-linear weighting function W(x,y) may also be employed as long as it meets the condition of equation 1.

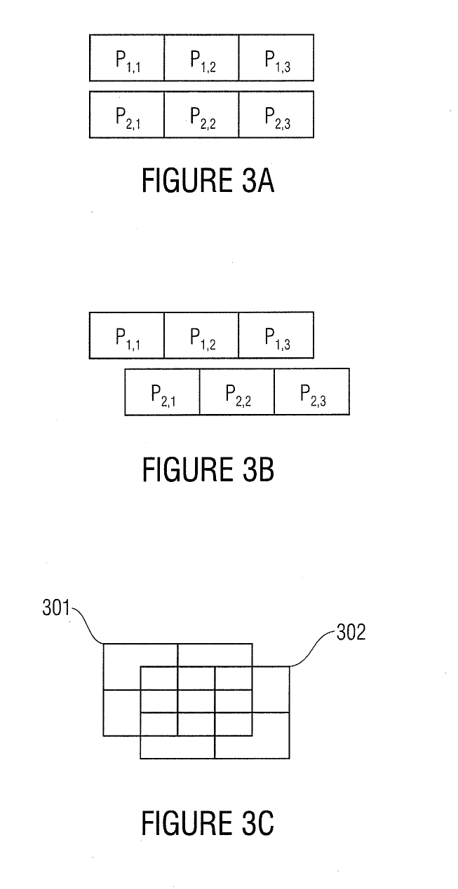

FIGS. 3a to 3c illustrate an offset between pixels in the overlap area, caused by previous geometric sub-image corrections, for example. FIG. 3a shows three pixels, respectively, of a first sub-image, designated by P_{1,1}, P_{1,2} and P_{1,3}, and of a second sub-image, which are designated by P_{2,1}, P_{2,2} and P_{2,3}. The orientation of the pixels in FIG. 3a indicates that there is no offset between the sub-images. Accordingly, the intensity of a pixel of the overall image could be calculated, for example, as

p₁=0.75·P_{1,1}+0.25·P_{2,1},

wherein in this case, the weighting factors are selected randomly in order to illustrate the embodiment. For illustration purposes, FIG. 3b, in turn, shows three pixels, respectively, of two sub-images, which are given identical designations to those in FIG. 3a. In comparison with FIG. 3a, however, the pixels in FIG. 3b exhibit an offset. In order to calculate, for example, an intensity of a pixel of the overall image which exhibits no offset as compared to the dots P_{2,*}, the intensity of the dots of the first sub-image P_{1,*}, in turn, could be weighted. For example,

p₁=0.375·P_{1,1}+0.375·P_{1,2}+0.25·P_{2,1}

would apply. In this manner, overlaps as also occur with the pixel grid of the overall image may be taken into account.

FIG. 3c also shows two overlapping subareas of two sub-images 301 and 302. FIG. 3c is to illustrate that there may also be overlaps of four or more pixels, which may be weighted in accordance with the embodiments of FIGS. 3a and 3b.

In accordance with FIGS. 3a to 3c, an offset between the pixels in the overlap area may form, for example, because of previous geometric image corrections. In order to nevertheless perform a correction which is precise within the sub-pixel range, it may thus be generally possible for an input pixel pᵢ(x,y) to not be composed of one pixel per sub-image M, but of n×m pixels. This case is feasible, in particular, when there are images of different resolutions. Also, the number of weighting factors scales with the number of pixels used.

$$p ( x . y ) = {\sum }_{i = 1}^{M} {\sum }_{k = 0}^{n} {\sum }_{j = 0}^{m} {W}_{i} ( x + k , y + j ) \cdot {p}_{i} ( x + k , y + j ) \\ with \\ {\sum }_{i = 1}^{M} {\sum }_{k = 0}^{n} {\sum }_{j = 0}^{m} {W}_{i} ( x + k , y + j ) = 1. \qquad ( eq . 2 )$$

By suitably selecting the weighting functions in relation to the overlap areas, artifacts in the overall image may be greatly reduced. As was already mentioned above, the weighting function may optionally be stored, in a suitable form, in a correction memory.

The means 120 for generating the overall image, for example an arithmetic unit, generates the corrected overall-image data, or output-image data, in that the image data from the individual sub-images is multiplied by corresponding weighting factors and is subsequently added up, possibly in dependence on existing data in the correction memory.

Depending on the embodiment of the present invention, it may also occur that in a resulting image, that is in an overall image, pronounced gray-scale jumps are still recognizable following the weighted averaging, which will be possible, for example, when the overlap area of the sensors or cameras is not large enough. In such a case it is possible to fall back on an area of pixels in the individual sub-images, which area is larger than the overlap area. In such a case, a pixel of the overall image therefore is not dependent solely on the overlapping pixels of the individual sub-images, but also on pixels of the sub-images in an environment of the pixel of the overall image. Therefore, it is also possible in this context to define, in accordance with equation 2, a multi-dimensional filter function which multiplies a sufficiently large number of pixels, for example by additionally taking into account pixels located immediately before the overlap area, by a suitable weighting function so as to thereby realize a smoother transition from one sensor to another. It is feasible, in this context, that a pixel in the overall image only results in dependence on the pixels of a sub-image and their weighting factors, i.e. that said pixel is influenced only by those pixels of the sub-image which are located at the same geometric position as the pixel of the overall image.

In another embodiment, a filter function is employed in this context, too, which means that a pixel in the overall image depends on weighting factors and on those pixels of the sub-images which are located at the same geometric position as the pixel in the overall image, and on those dots in a geometric environment around the geometric position of the pixel of the overall image. The remaining input pixels are then transmitted to the overall image unchanged.

In a general case, in one embodiment of the present invention, a pixel in the overall image would depend on all pixels of the sub-images, the weighting function associating a weighting factor with each pixel in each sub-image.

For reasons of clarity, the following contemplations refer to overlap areas of only two sub-images. Generally, overlaps of any number of sub-images are feasible, it being possible for the overlap areas to take on any shape.

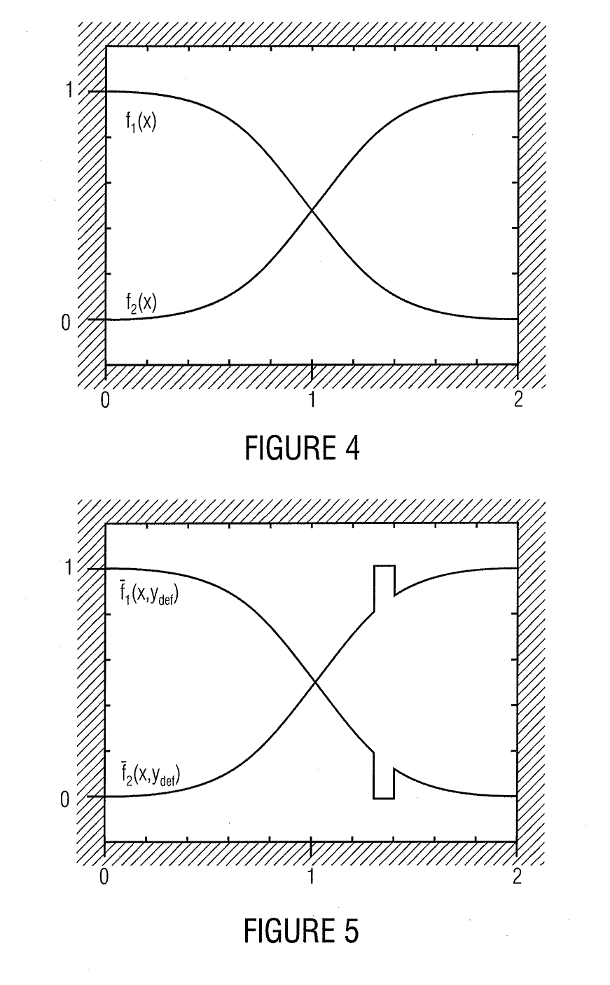

FIG. 4 shows two embodiments of weighting functions f₁(x) and f₂(x), which realize non-linear curves in an overlap area. In this context,

f₁(x)=e^{-(x-0,12)}^{^{δ}} (1)

and

f₂(x)=1−f₁(x) (2)

might be possible.

In FIG. 4, the progressions of the two functions occur across the definition range xε{0 . . . 2} and the values range f_{1/2}ε{0 . . . 1}. As may be seen from FIG. 4, both functions f₁(x) and f₂(x) meet the summation criterion, which prescribes that the sum is equal to 1 at each coordinate. Such non-linear weighting functions may serve, for example, to cross-fade or merge the sub-images in the margin or overlap area. Generally, any other functions are possible. The definition range and values range as was explained with reference to FIG. 4 shall also apply to the embodiments of weighting functions which will be explained in more detail below.

During the detection of the individual sub-images, defective pixels may occur, in particular if the individual sub-images are X-ray images. This may be due to a hardware defect of the image sensor, on the one hand, but also to aging phenomena which may occur, for example, with cameras or X-ray detectors, on the other hand. For detecting such defects it is feasible, for example, that one may establish, by means of calibration images having known contents, those pixels of the sub-images which are imaged correctly, and/or those pixels of the sub-images which are defective. What might be feasible as calibration images are bright images, for example, wherein each pixel of a sub-image should appear to be white, and wherein such pixels which do not exceed a minimum of brightness may be classified as defective. A similar approach would be feasible, for example, if dark images are used, i.e. such images which are to cause only dark or black pixels, and wherein those pixels which exceed a certain degree of brightness are classified as defective.

In the following it shall be assumed that defective pixels are known. FIG. 5 shows two exemplary weightings or weighting functions which further illustrate the approach of embodiments with a defective pixel. FIG. 5 shows the progressions of two functions

$$\begin{matrix}{\overline{f}}_{1} ( x , y ) = \{ \begin{matrix}0 & x = {x}_{def} ; y = y \\ {f}_{1} ( x ) & otherwise\end{matrix} \\ and & ( 3 ) \\ {\tilde{f}}_{2} ( x , y ) = 1 - {\tilde{f}}_{1} ( x , y ) . & ( 4 )\end{matrix}$$

The progressions of functions depicted in FIG. 5 represent, by way of example, a weighting function or merging function in the event of defective pixels or so-called pixel defects. In the defect area, which in FIG. 5 is between x=1,2 and x=1,4, it becomes clear that in the embodiment contemplated here, access is made exclusively to pixels from the intact sub-image in accordance with the function f₂(x,y). In accordance with equation 3, the defective pixel is located, in FIG. 5, at the coordinates x_{def}, y_{def}. One may see from FIG. 5 that defective pixels may be entirely faded out by the weighting. In this context, one falls back only on intact pixels of other sub-images. Similar embodiments take into account a plurality of sub-images within an area, it being possible to fade out those pixels which are defective in each case.

Embodiments therefore offer the advantage that, for example, aging effects of X-ray detectors, which translate into increasing pixel defects, may be compensated for. Generally, any number of defective pixels in the overlap area may be compensated for by means of the weighting functions. In addition, embodiments offer the possibility of fading in any newly added sub-images by means of the weighting functions at a later point in time. In particular in quality control of castings by means of X-ray images it is therefore possible to cover any image areas where an increased number of defective pixels occur by additional detectors and, thus, additional sub-images. The respective weighting functions, which may take on any form, also enable fading in sub-images which were inserted at a later point in time and which cover areas with more frequent defective pixels. In the quality control of aluminum castings, for example, X-ray detectors are frequently employed. Since the castings often exhibit a dimension which would not be detectable using one single X-ray detector, several X-ray detectors are frequently used in this context.

The respective stress imposed on the detectors by the X-radiation depends on their positions and, for example, on the shapes of the test pieces. It may occur, for example, that in quality control such sensors are subject to different degrees of wear and tear. Embodiments here offer the advantage that by performing calibration processes at correspondingly regular intervals, pixel defects in detectors subject to different degrees of stress may be compensated for, it being possible in this context to adapt the respective weightings accordingly.

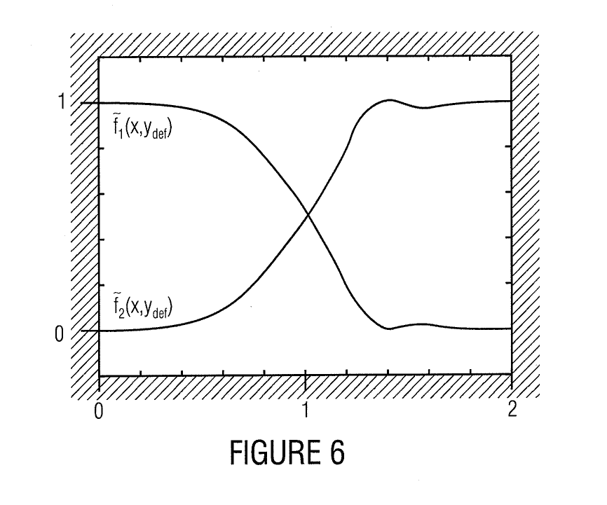

Further embodiments may comprise smoother fading in and/or fading out of defective dots. To this end, two further weighting functions are depicted in FIG. 6. Depending on the type of sub-images, there is the possibility that defective pixels will slightly stand out from their environments following the correction. With a simple interference treatment in an embodiment, there is the possibility, depending on the starting material, that a supplemented defective pixel slightly differs from its environment. It may therefore also be advantageous, in embodiments, to floatingly adapt the weighting functions in an environment of the defective pixel. Two such functions are depicted in FIG. 6. In comparison to the embodiments of the weightings depicted in FIG. 5, in FIG. 6 the defective pixel is not faded out hard and replaced by the corresponding pixel of the other sub-image, but is faded out smoothly, whereas the correct pixels of the other sub-image are faded in an correspondingly slower or smoother manner.

The embodiment of FIG. 6 clearly shows that a special treatment of the defective pixels is possible, since a dedicated merging function may be indicated for each individual pixel. Embodiments thus offer the advantage that any defective pixels in the sub-images may be corrected. This is relevant particularly when such defects do not occur individually, but are randomly distributed across the images.

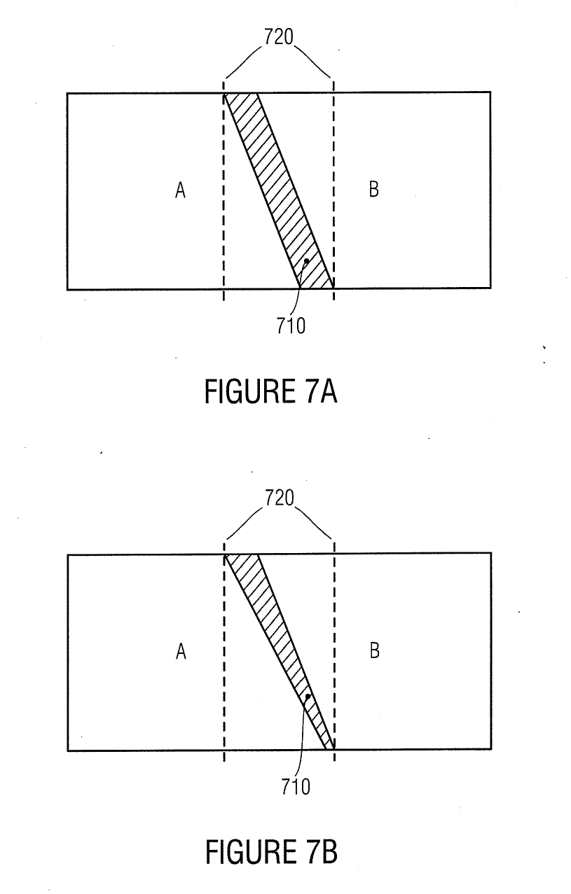

As was already mentioned in detail, the individual sub-images may initially be geometrically corrected, for example rotational or translational conversions as well as elongations or compressions are feasible. Depending on these geometric adaptations, the shapes of the respective overlap areas may deviate accordingly. If, therefore, the images are subject to geometric correction, in particular if this involves rotation, the overlap area will frequently no longer be rectangular. Embodiments of the present invention offer the advantage that the overlap areas of the individual sub-images may take on any shape. This may be caused by geometric corrections, on the one hand, but also by defective pixels, which are taken into account accordingly in the weighting functions, on the other hand. Generally, for a merging, as wide an overlap area as possible would be desirable. In reality, limitation to a rectangular area is often not possible. FIGS. 7a and 7b illustrate these effects. FIGS. 7a and 7b depict two sub-images A and B in each case, which overlap in a hashed area 710. The hashed area represents the effective overlap area 710. In addition, rectangular overlap areas 720, which are delimited by dashed lines, are depicted in FIGS. 7a and 7b. The overlap areas 720 correspond to rectangular overlap areas as are employed in conventional weighting methods.

In terms of the effective overlap areas 710, FIGS. 7a and 7b illustrate those areas to which the weighting functions may be adapted. In this context, any shapes of overlap areas may occur, as is to be illustrated by FIGS. 7a and 7b. Weighting functions which refer only to rectangular overlap areas may result in mismatches. In particular, strictly linear functions cannot adapt an area 710 as is depicted, for example, in FIG. 7b, in an optimum manner. The examples shown in FIGS. 7a and 7b clearly show that a weighting function which is globally applied to the entire overlap area is not ideal. In accordance with embodiments of the present invention, a weighting function may be adapted to the respective shape of an overlap area, and as a result, a more accurate superposition and, eventually, a better, higher-quality overall image may be generated.

Embodiments thus offer the advantage that any defective pixels and any overlap areas may be covered. Since any, even non-linear, weighting functions may be used, there is no limit to the shapes of the overlap areas. This is advantageous, in particular, when several sub-images overlap within an overlap area, the individual sub-images having been subjected to different geometric adaptations.

It shall be noted, in particular, that depending on the circumstances, the inventive scheme may also be implemented in software. The implementation may occur on a digital storage medium, in particular a disk or a CD with electronically readable control signals which may cooperate with a programmable computer system and/or microcontroller such that the respective method is performed. Generally, the invention thus also consists in a computer program product having a program code, stored on a machine-readable carrier, for performing the inventive method, when the computer program product runs on a computer and/or microcontroller. In other words, the invention may therefore be realized as a computer program having a program code for performing the method, when the computer program runs on a computer and/or microcontroller.

The present invention offers the advantage that in particular in the pre-processing of X-ray image data as occurs in the quality control or quality inspection of relatively large metallic components such as aluminum rims, for example, a more pronounced reduction of transition artifacts may be achieved in an overall image composed of individual sub-images. The inventive pre-processing of the image data, and the inventive composing and processing of the overlap areas thus enable improved quality control, wherein fewer false alarms occur which are due to gray jumps in the overlap areas of the sub-images.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus for reducing transition artifacts in an overall image composed of sub-images whose image areas comprise overlap areas, the apparatus comprising:
a storer for storing image data of the pixels of the sub-images; and
a generator for generating the overall image on the basis of the image data of the sub-images by superposition of the image data of the pixels in the overlap areas in accordance with a weighting,
each of the subareas in the overlap area comprising a weighting function associated with it, and
the weighting functions of the sub-images being modified, in the event of a defective pixel in one of the sub-images, at the position of the defective pixel such that the defective pixel is faded out entirely and that only intact pixels of the other sub-images are used, so that any influence of an incorrectly detected pixel of a sub-image which would cause an artifact in the overall image is reduced in the overall image.

2. The apparatus as claimed in claim 1, wherein the weighting functions of the sub-images are floatingly adapted in an environment of the defective pixel.

3. The apparatus as claimed in claim 1, wherein the sub-images comprise overlap areas which are not rectangular.

4. The apparatus as claimed in claim 1, further comprising a storer for storing the weighting.

5. The apparatus as claimed in claim 1, further comprising an outputter for outputting the overall image.

6. The apparatus as claimed in claim 1, wherein the generator for generating the overall image is configured to perform the weighting of the image data of a pixel in dependence on the geometric location of the pixel in relation to the overlap area.

7. The apparatus as claimed in claim 1, wherein the storer for storing is configured to store intensity information in image data of a pixel, and wherein the generator for generating the overall image is configured to generate the intensity of a pixel of the overall image in an overlap area in accordance with a linear combination of the intensity information of the pixels of the sub-images.

8. The apparatus as claimed in claim 7, wherein an intensity p(x,y) of a pixel comprising the coordinates x and y in the overall image results from
$$p ( x , y ) = {\sum }_{i = 1}^{M} {\sum }_{k = 0}^{n} {\sum }_{j = 0}^{m} {W}_{i} ( x + k , y + j ) \cdot {p}_{i} ( x + k , y + j )$$
$$with$$
$${\sum }_{i = 1}^{M} {\sum }_{k = 0}^{n} {\sum }_{j = 0}^{m} {W}_{i} ( x + k , y + j ) = 1 ,$$
wherein M is the number of sub-images, and wherein n×m pixels are used by each sub-image, respectively, for determining an intensity of a pixel of the overall image.

9. The apparatus as claimed in claim 1, wherein the generator for generating the overall image is configured to perform the superposition of image data of pixels beyond the overlap area.

10. The apparatus as claimed in claim 8, wherein the generator for generating the overall image is configured to render the weighting of the image data of a pixel of a sub-image at a pixel in the overall image dependent on its distance from the border of the overlap area.

11. The apparatus as claimed in claim 1, wherein the generator for generating the overall image is configured to render the image data of a pixel in the overall image dependent on a plurality of image data of pixels of a sub-image.

12. The apparatus as claimed in claim 1, wherein the storer for storing and the generator for generating the overall image are configured to process image data of those sub-images which comprise X-ray image data.

13. The apparatus as claimed in claim 12, wherein the image data of the sub-images comprises X-ray image data of sections of the same object.

14. A method for reducing transition artifacts in an overall image composed of sub-images whose image areas comprise overlap areas, the method comprising:
storing the image data of the pixels of the sub-images; and
generating the overall image on the basis of the image data of the sub-images by superposition of the image data of the pixels in the overlap areas in accordance with a weighting,
each of the subareas in the overlap area comprising a weighting function associated with it, and
the weighting functions of the sub-images being modified, in the event of a defective pixel in one of the sub-images, at the position of the defective pixel such that the defective pixel is faded out entirely and that only intact pixels of the other sub-images are used, so that any influence of an incorrectly detected pixel of a sub-image which would cause an artifact in the overall image is reduced in the overall image.

15. A computer program comprising a program code for performing the method for reducing transition artifacts in an overall image composed of sub-images whose image areas comprise overlap areas, the method comprising:
storing the image data of the pixels of the sub-images; and
generating the overall image on the basis of the image data of the sub-images by superposition of the image data of the pixels in the overlap areas in accordance with a weighting,
each of the subareas in the overlap area comprising a weighting function associated with it, and
the weighting functions of the sub-images being modified, in the event of a defective pixel in one of the sub-images, at the position of the defective pixel such that the defective pixel is faded out entirely and that only intact pixels of the other sub-images are used, so that any influence of an incorrectly detected pixel of a sub-image which would cause an artifact in the overall image is reduced in the overall image,
when the program code is executed on a computer.
